(19) United States
(12) Patent Application Publication
(10) Pub. No.: US 2012/0203497 A1
(43) Pub. Date: Aug. 9, 2012

(54) DETECTING DEVICE, IMAGE FORMING APPARATUS, COMPUTER PROGRAM PRODUCT, AND DETECTING SYSTEM

(76) Inventors: Jun YAMANE, Kanagawa (JP); Tatsuya WATAHIKI, Kanagawa (JP); Takahisa KOIKE, Tokyo (JP)

(21) Appl. No.: 13/367,499

(22) Filed: Feb. 7, 2012

(30) Foreign Application Priority Data
Feb. 8, 2011 (JP) 2011-025378
Jan. 11, 2012 (JP) 2012-003353

(51) Int. Cl. G06F 15/00; B65H 5/00

(52) U.S. Cl. 702/145; 271/264

(57) ABSTRACT

A detecting device includes: a measuring unit that measures a rotating speed of at least one of connected gears; a calculating unit that calculates frequency characteristics for the rotating speed measured by the measuring unit; a detecting unit that detects a period of fluctuation of the rotating speed measured by the measuring unit; a determining unit that determines whether the connected gears include a damaged gear by using the frequency characteristics calculated by the calculating unit; and an identifying unit that, if the determining unit determines that the connected gears include a damaged gear, identifies a gear whose rotation period corresponds to the period detected by the detecting unit as the damaged gear among the connected gears.

### CROSS-REFERENCE TO RELATED APPLICATIONS

The present application claims priority to and incorporates by reference the entire contents of Japanese Patent Application No. 2011-025378 filed in Japan on Feb. 8, 2011 and Japanese Patent Application No. 2012-003353 filed in Japan on Jan. 11, 2012.

### BACKGROUND OF THE INVENTION

1. Field of the Invention

The present invention relates to a detecting device that detects damage to a connected gear, an image forming apparatus, a computer program product, and a detecting system.

2. Description of the Related Art

In a device, such as a copier or image forming apparatus, that includes a rotary driving system, a gear transmission mechanism is used to reduce the rotating speed of the motor. The gear transmission mechanism has a combination of gears that each have a different diameter. In such a gear transmission mechanism, a gear is often damaged due to abrasion or overloading, and the damage causes the device to operate abnormally. Therefore, if it is possible to predict, diagnose, and detect damage to gears, it is highly useful for maintenance of the device.

For example, Japanese Patent Application Laid-open No. H2-311735 discloses a technology for detecting a problem with a gear by using the level of the mesh frequency component of the gear and the attenuation tendency of the frequency components, which are obtained with respect to the mesh frequency and are separated at the intervals of the shaft rotating speed. Furthermore, Japanese Patent No. 4229823 discloses a technology for determining the presence or absence of gear damage by using the frequency characteristics of the motor torque and the motor rotating speed. Moreover, Japanese Patent Application Laid-open No. 2009-180304 discloses a technology in which a Fourier transform is performed on the rotation signals from the gear driving system and an abnormal part of the gear is identified on the basis of the amplitude value of the mesh frequency component of each gear.

If only the mesh frequency component of the gears is monitored, it is not possible to identify which one of the meshing gears is causing a problem. Therefore, there is a problem in that, even if the technologies disclosed in Japanese Patent Application Laid-open No. H2-311735, Japanese Patent No. 4229823, and Japanese Patent Application Laid-open No. 2009-180304 are used, it is extremely difficult to identify which gear of the shaft is damaged in a unit that is connected by gears.

Therefore, there is a need for a detecting device capable of easily identifying a damaged gear among connected gears.

### SUMMARY OF THE INVENTION

It is an object of the present invention to at least partially solve the problems in the conventional technology.

According to an embodiment, there is provided a detecting device that includes: a measuring unit that measures a rotating speed of at least one of connected gears; a calculating unit that calculates frequency characteristics for the rotating speed measured by the measuring unit; a detecting unit that detects a period of fluctuation of the rotating speed measured by the measuring unit; a determining unit that determines whether the connected gears include a damaged gear by using the frequency characteristics calculated by the calculating unit; and an identifying unit that, if the determining unit determines that the connected gears include a damaged gear, identifies a gear whose rotation period corresponds to the period detected by the detecting unit as the damaged gear among the connected gears.

According to another embodiment, there is provided an image forming apparatus that includes: a sheet conveying unit that conveys a sheet by using a moving body, the moving body being driven via connected gears; an image forming unit that forms an image on the sheet conveyed by the sheet conveying unit by using a rotary drum that is driven and rotated via connected gears; and the detecting device according to the above embodiment, the detecting device detecting damage to at least one of the connected gears of the sheet conveying unit and the image forming unit.

According to still another embodiment, there is provided a computer program product that includes a non-transitory computer readable medium including programmed instructions. The instructions, when executed by a computer, cause the computer to execute: measuring a rotating speed of at least one of connected gears; calculating frequency characteristics for the rotating speed measured at the measuring; detecting a period of fluctuation of the rotating speed measured at the measuring; determining whether the connected gears include a damaged gear by using the frequency characteristics calculated at the calculating; and identifying, if it is determined at the determining that the connected gears include a damaged gear, a gear whose rotation period corresponds to the period detected at the detecting as the damaged gear among the connected gears.

According to still another embodiment, there is provided a detecting system for detecting damage to connected gears. The detecting system includes: a device that includes the connected gears and an output unit that outputs a signal in accordance with rotation of at least one of the connected gears; a measuring unit that measures a rotating speed of at least one of the connected gears in accordance with the signal output from the output unit; a calculating unit that calculates frequency characteristics for the rotating speed measured by the measuring unit; a detecting unit that detects a period of fluctuation of the rotating speed measured by the measuring unit; a determining unit that determines whether the connected gears include a damaged gear by using the frequency characteristics calculated by the calculating unit; and an identifying unit that, if the determining unit determines that the connected gears include a damaged gear, identifies a gear whose rotation period corresponds to the period detected by the detecting unit as the damaged gear among the connected gears.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram that schematically illustrates an exemplary configuration of an image forming apparatus that can be used in a first embodiment;

FIG. 2 is a schematic diagram that illustrates, in a more detailed manner, an exemplary configuration of a driving system for driving an intermediate transfer belt;

FIG. 3 is a schematic diagram that illustrates an exemplary configuration of a rotary encoder in a more detailed manner;

FIG. 4 is a block diagram that illustrates exemplary configurations of a pulse detecting unit and a driving control unit in a more detailed manner;

FIG. 5 is a graph that illustrates an example of the analysis result obtained by analyzing the frequency characteristics for the rotating speed of a drive roller;

FIG. 6 is a graph that illustrates an exemplary result of the calculation of an auto-correlation function with respect to the rotating speed of the drive roller;

FIG. 7 is a block diagram that illustrates an exemplary configuration of a damaged-gear detecting device according to the first embodiment;

FIG. 8 is a block diagram that illustrates an exemplary configuration of a gear-damage detecting unit;

FIG. 9 is a block diagram that illustrates an exemplary configuration of a damaged-gear identifying unit;

FIG. 10 is an exemplary flowchart that illustrates the motor control and damaged-gear detection process performed by the gear-damage detecting device according to the first embodiment;

FIG. 11 is an exemplary flowchart that illustrates the damaged-gear detection process according to the first embodiment in a more detailed manner;

FIG. 12 is a schematic diagram that illustrates an exemplary configuration of the driving system that drives a photosensitive drum;

FIG. 13 is a block diagram that illustrates an exemplary configuration of a damaged-gear detecting device according to a second embodiment;

FIG. 14 is a block diagram that illustrates an exemplary configuration of the damaged-gear identifying units;

FIG. 15 is an exemplary flowchart that illustrates the damaged-gear detection process according to the second embodiment in a more detailed manner;

FIG. 16 is a block diagram that illustrates an exemplary hardware configuration of a multifunction peripheral that can be used in each of the embodiments and the modified example;

FIG. 17 is an external view of an example of a detecting system according to a fourth embodiment; and

FIG. 18 is a block diagram that illustrates an exemplary configuration of the detecting system.

### DETAILED DESCRIPTION OF THE PREFERRED EMBODIMENTS

Embodiments of a gear-damage detecting device will explained in detail below with reference to the accompanying drawings. According to the embodiments, the frequency characteristics for the rotating speed of one of the connected gears are calculated and, if the peak of the mesh frequency is greater than or equal to a threshold, it is determined that the connected gears include a damaged gear. If it is determined that the connected gears include a damaged gear, the period of fluctuation of the rotating speed of any one of the connected gears is detected, and, out of the connected gears, the gear whose rotation period corresponds to the detected period is identified as the damaged gear.

In the following, explanation is given of examples where the gear-damage detecting devices according to the embodiments are used in an image forming apparatus, such as a copier that forms color images; however, applicable apparatuses are not limited to this. Applicable apparatuses include, for example, a printing device that receives image data from an external controller, such as a personal computer (PC), and forms images. The gear-damage detecting device may be used in image forming apparatuses, for example, copiers, printers, scanners, facsimile machines, and multifunction peripherals that have at least two functions out of copying, printing, scanning, and facsimile functions. Furthermore, the gear-damage detecting devices according to the embodiments can be used in not only image forming apparatus but also other types of apparatuses if they have a structure for transmitting power by using multiple gears that are connected to each other.

### First Embodiment

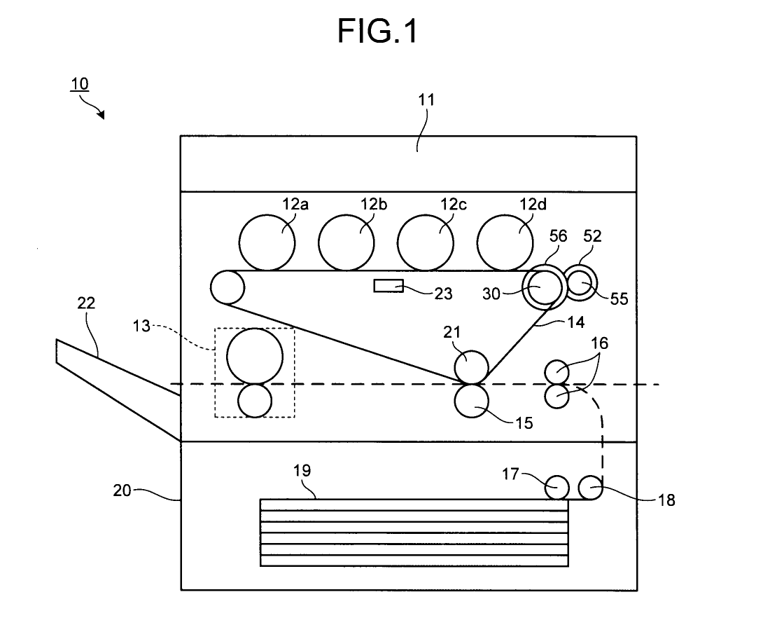

FIG. 1 schematically illustrates an exemplary configuration of an image forming apparatus 10 that can be used in a first embodiment. In the first embodiment, an explanation is given of an example of the detection of damage to gears that drive an intermediate transfer belt used in a color copier. As illustrated in FIG. 1, the image forming apparatus 10 includes a scanner unit 11, photosensitive units 12a to 12d, a fixing unit 13, an intermediate transfer belt 14, a secondary transfer roller 15, registration rollers 16, a feed roller 17, a sheet conveying roller 18, a transfer sheet 19, a feed unit 20, a repulsive roller 21, a discharge unit 22, and an intermediate-transfer scale detection sensor 23.

The scanner unit 11 reads images of a document that is placed on the top of a platen. The photosensitive units 12a to 12d correspond to four colors: yellow (Y), cyan (C), magenta (M), and black (K), respectively, and each include a photosensitive drum that is a drum-like latent-image carrier, a photosensitive cleaning roller, and the like. In the following, they may be simply referred to as a photosensitive unit 12 if their colors are not specified.

The fixing unit 13 fixes a transferred toner image to a transfer sheet. The intermediate transfer belt 14 superimposes color images formed by the photosensitive units 12a to 12d and transfers them to a transfer sheet. The intermediate transfer belt 14 is driven by a drive roller 30. The drive roller 30 is driven by a motor 52 at a reduced rotating speed via gears 55 and 56, which are connected to each other and which each have a different number of teeth.

The secondary transfer roller 15 transfers the images on the intermediate transfer belt 14 to a transfer sheet. The registration rollers 16 correct the skew of the transfer sheet, convey the transfer sheet, and the like. The feed roller 17 delivers the transfer sheet from the feed unit 20 to a conveying section. The sheet conveying roller 18 conveys the transfer sheet 19, which has been delivered by the feed roller 17, to the registration rollers 16.

The transfer sheets 19 are stacked in the feed unit 20. The repulsive roller 21 is located at a position where it is opposed to the secondary transfer roller 15. The repulsive roller 21 generates and retains the nip between the intermediate transfer belt 14 and the secondary transfer roller 15. A transfer sheet, to which images have been transferred and fixed, is discharged into the discharge unit 22. The intermediate-transfer scale detection sensor 23 detects the scale formed on the intermediate transfer belt 14 and generates pulse outputs.

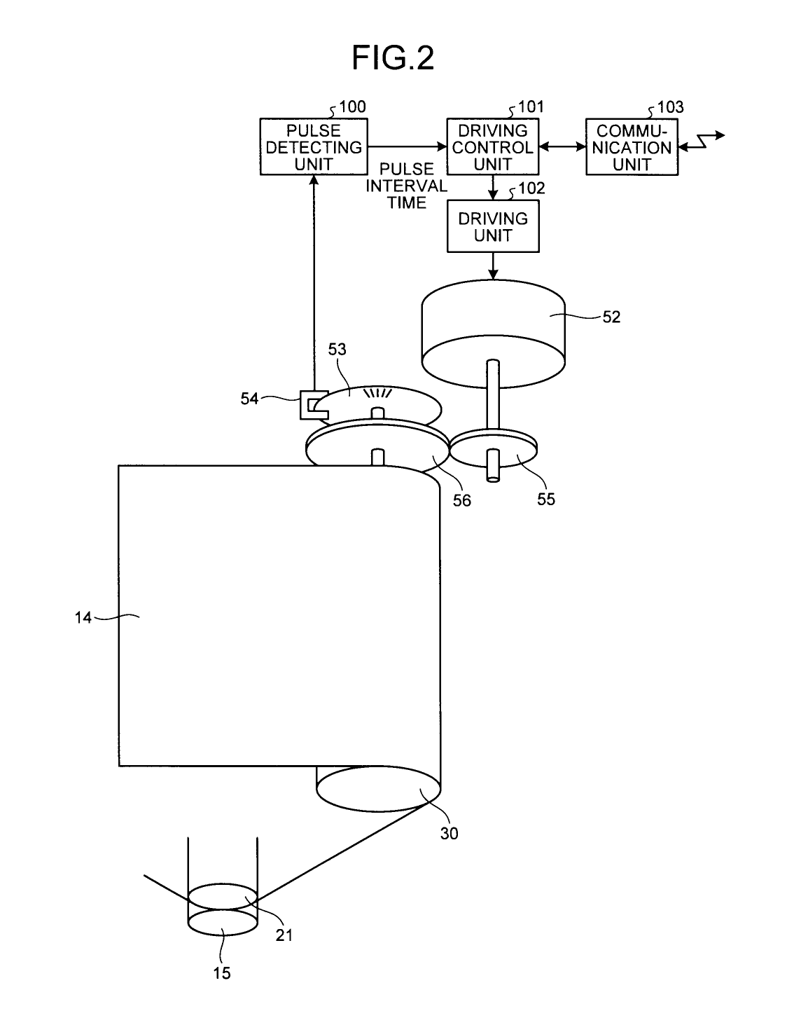

FIG. 2 illustrates, in a more detailed manner, an exemplary configuration of a driving system for driving the intermediate transfer belt 14. The motor 52 is driven by a driving unit 102 under the control of a driving control unit 101. The drive roller 30 that drives the intermediate transfer belt 14 is driven by the gear 55, which is attached to the rotation shaft of the motor 52, and by the gear 56, which is connected to the gear 55, while the rotating speed of the motor 52 is reduced.

In the example of FIG. 2, a code wheel 53 is provided in a concentric manner with respect to the gear 56. The code wheel 53 and a pulse generating unit 54 constitute a rotary encoder, and the code wheel 53 rotates together with the gear 56.

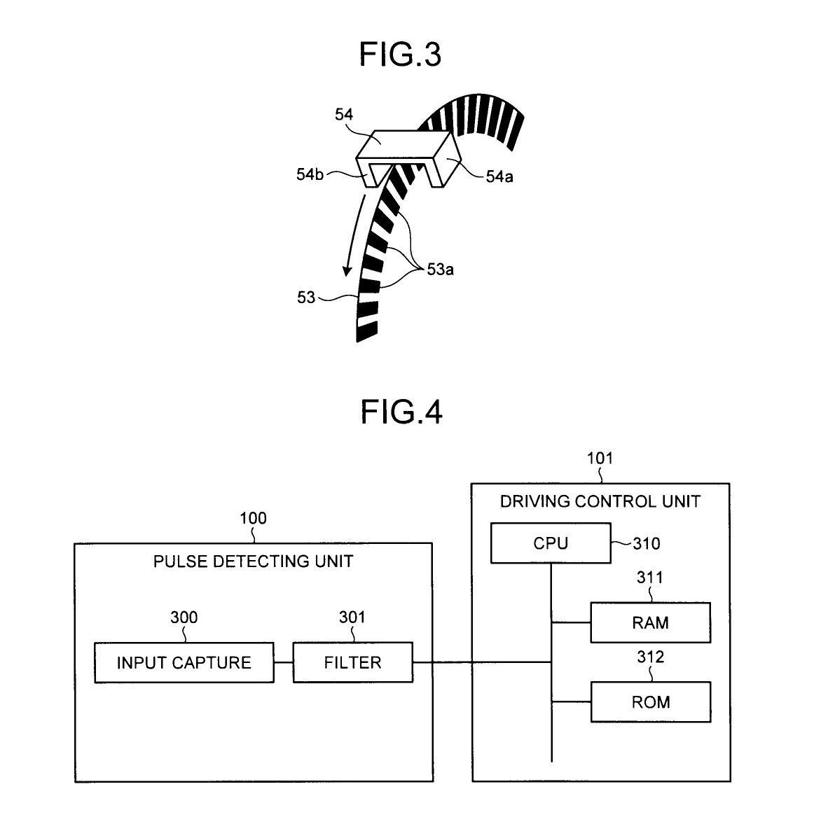

FIG. 3 illustrates an exemplary configuration of the rotary encoder in a more detailed manner. A rotary scale is provided on the outer periphery of the code wheel 53. For example, light-blocking black slits 53a are arranged at equal intervals on the outer periphery of the transparent code wheel 53, whereby the rotary scale is formed. The pulse generating unit 54 is a transmission optical sensor. Light emitted by a light-emitting unit 54a is received by a light-receiving unit 54b, and then a light-received signal is output. The code wheel 53 and the pulse generating unit 54 are arranged such that the light emitted by the light-emitting unit 54a is blocked by the slits 53a of the code wheel 53. Thus, the pulse generating unit 54 can output pulse signals at the time interval corresponding to the rotating speed of the code wheel 53.

As illustrated in FIG. 2, a pulse signal output from the pulse generating unit 54 is fed to a pulse detecting unit 100. The pulse detecting unit 100 measures the time interval between the pulses in the fed pulse signals and then outputs data on the measured pulse time interval. The data on the pulse time interval is output, for example, each time the light-receiving unit 54b receives light from the light-emitting unit 54a, and the data is fed to the driving control unit 101.

The driving control unit 101 refers to the pulse interval time so as to control the speed of the motor 52. For example, the driving control unit 101 compares the received pulse interval time with a target pulse interval time and then performs feedback control in accordance with the result of the comparison on the rotating speed of the motor 52. The driving unit 102 drives the motor 52 in response to a command received from the driving control unit 101. A communication unit 103 transmits and receives data to and from other components in the image forming apparatus 10 or an external device.

A control method performed by the driving control unit 101 is not limited to a method that directly uses the actual time, such as the pulse interval time. Any technique may be used as long as it uses a unit system that enables measurement of the rotating speed of the drive roller 30. The feedback control is not limited to a control using a speed but may be a control using a position or using a speed and position. Furthermore, depending on the characteristics of the control system, the control may be performed in a feedforward method or in a combination of feedback control and feedforward control.

FIG. 4 illustrates exemplary configurations of the pulse detecting unit 100 and the driving control unit 101 in a more detailed manner. In the example of FIG. 4, the pulse detecting unit 100 includes an input capture 300 and a filter 301. The input capture 300 measures pulse interval time. The filter 301 removes improper data caused by disturbance noise, or the like, and performs a filtering process, such as averaging.

The driving control unit 101 includes a central processing unit (CPU) 310, a random access memory (RAM) 311, and a read only memory (ROM) 312. The CPU 310 operates in accordance with programs and data, which are pre-stored in the ROM 312, and uses the RAM 311 as a working memory. For example, the driving control unit 101 uses the pulse interval time, which is fed from the pulse detecting unit 100, to perform a calculation operation so that the drive roller 30 rotates at a constant speed without rotation variations. The driving control unit 101 then generates a drive control signal so that the speed of the motor is in accordance with the result of the operation.

The CPU 310 is not always provided specifically for the driving control unit 101 and the function of part of a CPU for controlling a larger component may be used. The same applies to the RAM 311 and the ROM 312.

The use of the configuration illustrated in FIG. 2 enables frequency analysis of the pulse interval time by using a technique, such as a Fourier transform, and enables detection of rotation variations of the driving system of the drive roller 30. Data on which frequency analysis is performed by using a Fourier transform is not limited to the pulse interval time, and any data can be used as long as it is a signal in accordance with the driving of the motor 52 or the drive roller 30, which is a moving body driven (rotated) by the motor 52.

Next, a more detailed explanation is given of a method of identifying a damaged gear according to the first embodiment. According to the first embodiment, the rotating speed of the drive roller 30 is first measured, analysis is conducted on the frequency characteristics for the measured rotating speed by using a technique, such as a Fourier transform, and, if the value between the peaks (peak-to-peak) of the mesh frequency fₘ of the gears 55 and 56 exceeds a threshold, it is determined that at least one of the gears 55 and 56 is damaged.

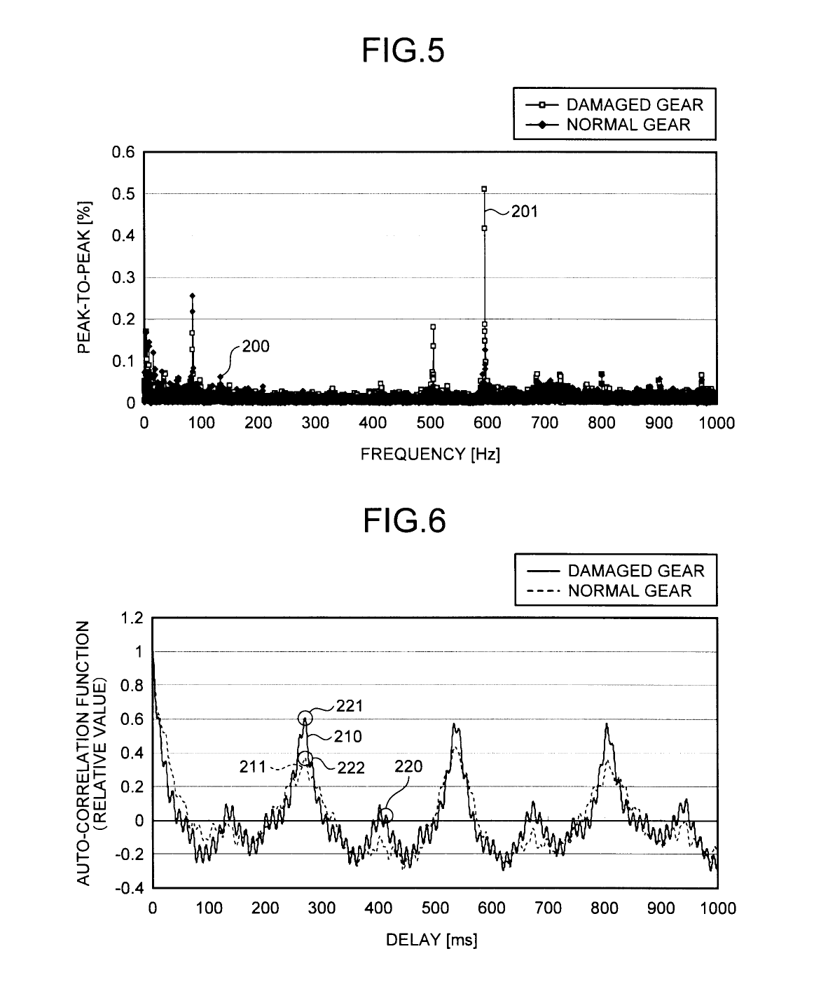

FIG. 5 illustrates an example of the analysis result obtained by analyzing the frequency characteristics for the rotating speed of the drive roller 30. In FIG. 5, the horizontal axis represents the frequency, and the vertical axis represents the peak-to-peak value, where the conveying speed of the intermediate transfer belt 14 (the rotating speed of the drive roller 30) is used as a reference. In this example, the range from 0 Hz to 1000 Hz is the target to be analyzed. If the maximum frequency to be analyzed is fₘₐₓ and the basic frequency (frequency resolution) is f_{bas}, frequency analysis is performed by using measured data, the number of samples of which is calculated from 2×fₘₐₓ/f_{bas}, and is performed by using a discrete Fourier transform (DFT). Moreover, the gear ratio of the gear 55 to the gear 56 is 1:10, the rotation period of the gear 55 is 27 msec (37.1 Hz) , the rotation period of the gear 56 is 270 msec (3.71 Hz), and the mesh frequency of the gears 55 and 56 is 600 Hz.

FIG. 5 illustrates a comparison between the analysis result 200 (indicated by the black diamond shapes in the drawing) of the frequency characteristics, which is obtained when both the gears 55 and 56 are normal gears without any damage, and the analysis result 201 (indicated by the squares in the drawing) of the frequency characteristics, which is obtained when the gear 55 and the gear 56 include a damaged gear. The damaged gear is obtained by breaking part of the teeth of any one of the gears 55 and 56.

As illustrated in FIG. 5, if the connected gears include a damaged gear, the value of the mesh frequency component (600 Hz) increases rather than the value of the rotation period component (3.71 Hz) of the drive shaft (the gear 56). Thus, it can be determined whether the connected gears include a damaged gear on the basis of the value of the mesh frequency component. Specifically, if the value of the mesh frequency component exceeds a threshold, it is determined that a damaged gear is included. In the example of FIG. 5, a threshold, for example, about 0.2%, may be selected.

Furthermore, frequency component analysis may be performed in advance in the normal state where the connected gears do not have any damage, and it may be determined whether the connected gears include a damaged gear on the basis of the ratio of the frequency component of the mesh frequency in the normal state to the mesh frequency component that is based on the value measured during driving.

The reason why the value of the mesh frequency component increases if the connected gears include a damaged gear may be that the vibration obtained when a damaged part of the damaged gear meshes with another gear remains on the normal part of the damaged gear.

If it is determined that the connected gears include a damaged gear, the damaged gear is identified by using an auto-correlation function for the rotating speed of the drive roller 30, which is obtained during measurement. For example, an auto-correlation function is calculated with respect to the rotating speed by using the data on the rotating speed of the drive roller 30 that is used during the above-described frequency characteristics analysis. The peaks of the value of the calculated auto-correlation function are detected, and a delay time is obtained that corresponds to the peak with the maximum value among the detected peaks. The gear whose rotation period nearly matches the obtained delay time is identified as a damaged gear. Thus, it is possible to identify a damaged gear among the connected gears.

Because the value of the auto-correlation function increases if the delay time is zero or nearly zero, it is preferable that the detection of peak values is performed in consideration of this point. For example, it is possible that a predetermined range from the point where the delay time m=0 is excluded from the target for which peak values are detected.

FIG. 6 illustrates an exemplary result of the calculation of an auto-correlation function with respect to the rotating speed of the drive roller 30. In FIG. 6, the vertical axis represents a relative value of an auto-correlation function and represents a value obtained by normalizing the value of the auto-correlation function by using the value for which the delay is zero, i.e., by using the power of a signal. The horizontal axis represents the delay time. FIG. 6 illustrates the comparison between an auto-correlation function 210, which is obtained if the gears 55 and 56 include a damaged gear, and an auto-correlation function 211, which is obtained if both the gears 55 and 56 are normal gears without any damage. In the same manner as described above, a damaged gear is obtained by breaking part of the teeth of any one of the gear 55 and the gear 56.

For the auto-correlation function, a signal has a period corresponding to the delay by which the value of the auto-correlation function increases. In the example of FIG. 6, for the auto-correlation functions 210 and 211, a low peak 220 corresponds to the mesh frequency of the gears 55 and 56. With respect to higher peaks 221 and 222, which have a large interval, the interval between the delay times is about 270 msec and corresponds to the rotation period of the gear 56 on the drive roller 30 side.

If the auto-correlation function 210, which is obtained when a damaged gear is included, is compared with the auto-correlation function 211, which is obtained in the case of normal gears, the value of the peak of the auto-correlation function 210 is significantly larger than that of the auto-correlation function 211. However, there are no recognizable peaks for the delay of 27 msec and its multiples, which correspond to the gear 55 on the motor 52 side. Therefore, it can be determined that the gear 56 on the drive roller 30 side is damaged on the basis of the delay time of the peak 221 of the auto-correlation function 210.

This may be because the damaged part of the gear has a different shape from that of a normal part where there is no damage and, when the damaged part meshes with another gear, a certain amount of vibration is generated. As illustrated in FIG. 6, the peaks are also generated at the delay corresponding to the rotation period of the gear 56, which is a normal gear. This may be related to the gear 56 itself, meshing of the gears 55 and 56, or the accuracy of the shaft of the gear 56.

As described above, with respect to the auto-correlation function 210 that is obtained if a damaged gear is included, the maximum peak value is detected and the delay time corresponding to the detected peak value is obtained so that a damaged gear can be identified from the connected gears.

Specifically, as explained with reference to FIG. 5, the gear mesh frequency component in the frequency characteristics for the rotating speed of the gear 55 or 56 is compared with a threshold so that it is determined whether the gears 55 and 56 include a damaged gear. If it is determined that the gears 55 and 56 include a damaged gear, the maximum peak value is detected from the auto-correlation function for the rotating speed of the gear 55 or 56. Out of the gears 55 and 56, a gear whose rotation period corresponds to the delay time by which the detected peak value is obtained is identified as a damaged gear. It is determined whether the connected gears include a damaged gear and, if a damaged gear is included, the damaged gear is identified; thus, it is possible to identify a damaged gear more definitely.

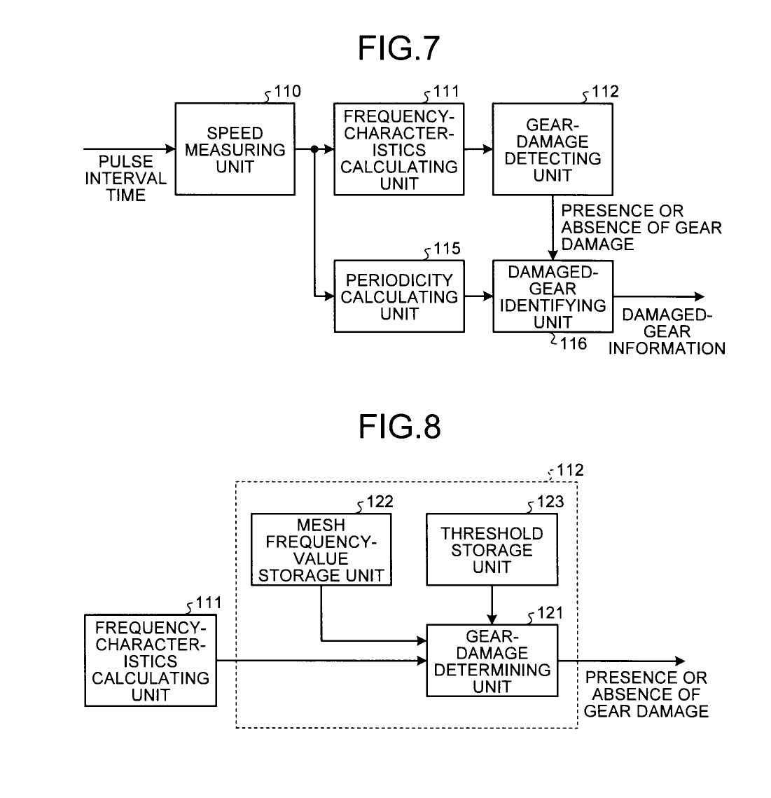

With reference to FIGS. 7 to 9, an explanation is given of an exemplary configuration for identifying a damaged gear by using the above-described method according to the first embodiment. FIG. 7 illustrates an exemplary configuration of a damaged-gear detecting device according to the first embodiment. The damaged-gear detecting device is included in, for example, the driving control unit 101. The damaged-gear detecting device includes a speed measuring unit 110, a frequency-characteristics calculating unit 111, a gear-damage detecting unit 112, a periodicity calculating unit 115, and a damaged-gear identifying unit 116.

Each unit included in the damaged-gear detecting device is configured as, for example, a module of a damaged-gear detection program that is operated by the CPU 310 included in the driving control unit 101. Specifically, the CPU 310 reads the damaged-gear detection program from the ROM 312, loads a module for configuring each unit of the damaged-gear detecting device to the RAM 311, and executes it. Furthermore, each unit included in the damaged-gear detecting device may be configured as hardware.

Data on the pulse interval time, which is output from the pulse detecting unit 100, is fed to the speed measuring unit 110. The speed measuring unit 110 calculates the rotating speed of the gear 56 by using the pulse interval time so as to obtain data on the rotating speed. The speed measuring unit 110 holds the amount of data on the rotating speed that is necessary for calculation of the frequency characteristics and the periodicity performed by the frequency-characteristics calculating unit 111 and the periodicity calculating unit 115. For example, it is possible that the speed measuring unit 110 holds at least the amount of data by which the largest rotation period out of the rotation periods of the gears to be detected for damage can be analyzed by using a discrete Fourier transform.

The frequency-characteristics calculating unit 111 performs, for example, a discrete Fourier transform on data on the rotating speed of the gear 56, which is held by the speed measuring unit 110, so as to calculate the frequency characteristics for the rotating speed. As a result of the calculation, the peak-to-peak value in each frequency within a predetermined range can be obtained as frequency characteristic data.

Although the frequency characteristics are calculated by using a discrete Fourier transform in the above explanation, the calculation is not limited to this example. For example, the frequency characteristics may be calculated by using a discrete cosine transform or various types of wavelet transform.

FIG. 8 illustrates an exemplary configuration of the gear-damage detecting unit 112. The gear-damage detecting unit 112 includes a gear-damage determining unit 121, a mesh frequency-value storage unit 122, and a threshold storage unit 123. The mesh frequency-value storage unit 122 pre-stores therein the value of the mesh frequency of the gear 55 and the gear 56. The threshold storage unit 123 pre-stores therein an experimentally obtained threshold.

The gear-damage determining unit 121 refers to the value of the mesh frequency, which is stored in the mesh frequency-value storage unit 122, and extracts the peak-to-peak value in the mesh frequency from the data on the frequency characteristics, which is calculated by the frequency-characteristics calculating unit 111. Then, the threshold stored in the threshold storage unit 123 is compared with the peak-to-peak value in the mesh frequency so that it is determined whether the peak-to-peak value exceeds the threshold. If it is determined that the peak-to-peak value exceeds the threshold, it is determined that the gear 55 and the gear 56 include a damaged gear. If it is determined that the peak-to-peak value does not exceed the threshold, it is determined that a damaged gear is not included. The gear-damage determining unit 121 outputs gear-damage presence/absence information, which indicates the presence or absence of gear damage, as an output from the gear-damage detecting unit 112.

As illustrated in FIG. 7, the periodicity calculating unit 115 uses data on the rotating speed of the gear 56, which is held by the speed measuring unit 110, to obtain the period of fluctuation of the rotating speed. More specifically, the periodicity calculating unit 115 calculates an auto-correlation function for the rotating speed. For example, peaks in the auto-correlation function are determined so that the period of fluctuation of the rotating speed can be obtained. If the gear-damage detecting unit 112 outputs the gear-damage presence/absence information, which indicates the presence of gear damage, the damaged-gear identifying unit 116 performs a process to identify a damaged gear from the gears 55 and 56 on the basis of the auto-correlation function, which is calculated by the periodicity calculating unit 115.

In the above explanation, the periodicity calculating unit 115 calculates an auto-correlation function so as to obtain the periodicity of fluctuation of the rotating speed; however, it is not limited to this example. For example, the periodicity of the rotating speed can be obtained by using various types of cepstrum analysis.

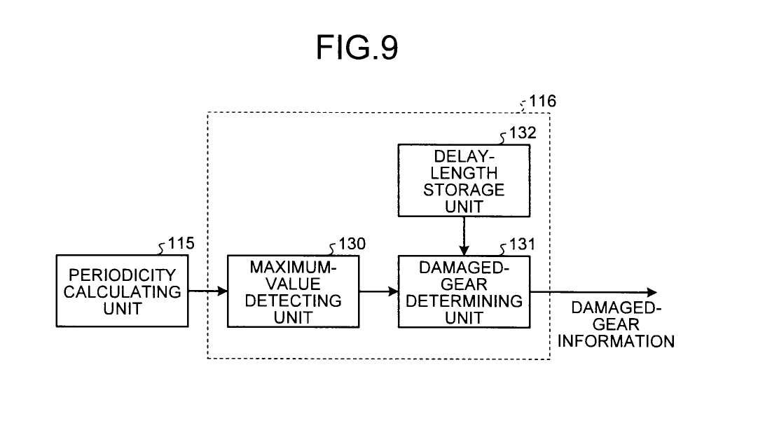

FIG. 9 illustrates an exemplary configuration of the damaged-gear identifying unit 116. The damaged-gear identifying unit 116 includes a maximum-value detecting unit 130, a damaged-gear determining unit 131, and a delay-length storage unit 132. The delay-length storage unit 132 stores therein the delay time corresponding to the rotation period with respect to each of the gear 55 and the gear 56, where the delay times are stored in association with the gear 55 and the gear 56.

The maximum-value detecting unit 130 detects the peak that has the maximum peak value from the peaks for the auto-correlation function, which is calculated by the periodicity calculating unit 115. Because the value of the auto-correlation function increases if the delay length is nearly zero, the peaks are detected in consideration of this point. For example, it is possible that peaks are detected for which the delay length is greater than or equal to a predetermined delay length. When the peak that has the maximum value is detected, the maximum-value detecting unit 130 outputs the delay time (referred to as a peak delay time) corresponding to the detected peak.

The damaged-gear determining unit 131 searches for the delay time that nearly matches the peak delay time, which is output from the maximum-value detecting unit 130, among the delay times stored in the delay-length storage unit 132. Then, the gear corresponding to the searched delay time is identified as a damaged gear. The damaged-gear determining unit 131 outputs damaged-gear information, which indicates the identified damaged gear, as an output from the damaged-gear identifying unit 116.

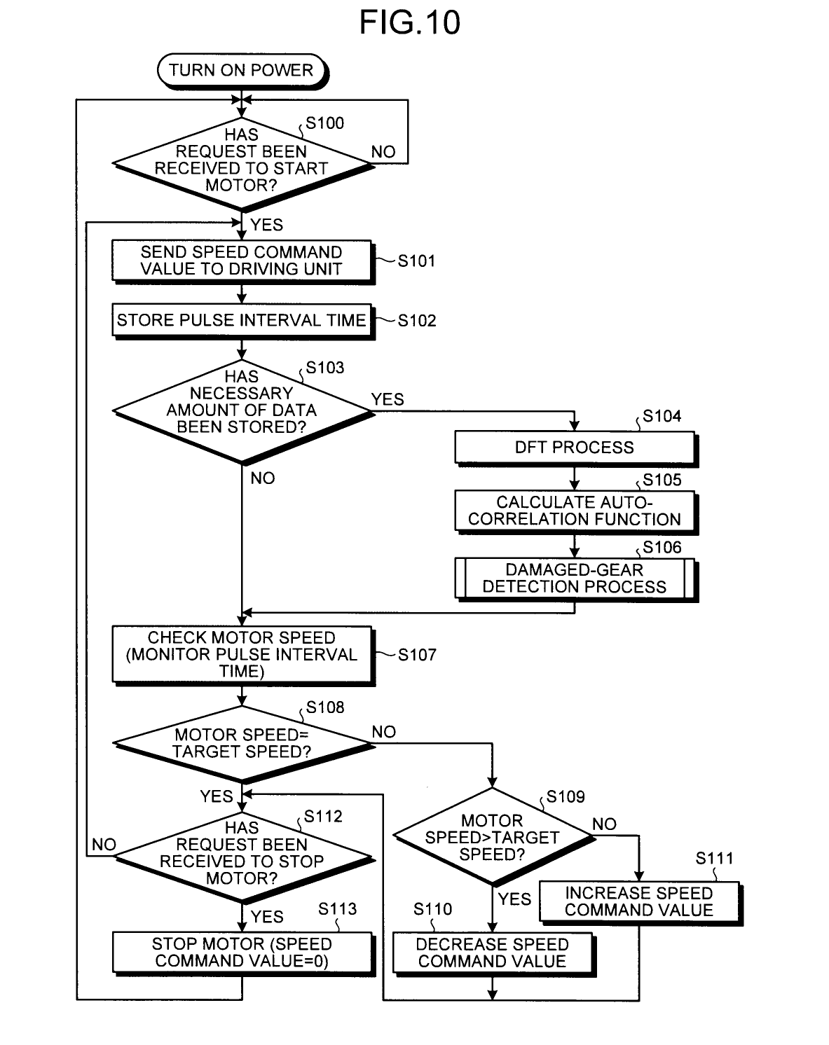

FIG. 10 is an exemplary flowchart that illustrates the motor control and damaged-gear detection process performed by the gear-damage detecting device according to the first embodiment. First, at Step S100, the driving control unit 101 waits for a request for start-up of the motor 52. When the start-up of the motor 52 is requested, the driving control unit 101 proceeds to the process at Step S101 and sends a command value of the rotating speed of the motor 52 to the driving unit 102. Thus, the driving control unit 101 starts to control the speed of the motor 52. In accordance with the rotation of the gear 56, which is connected to the gear 55 of the motor 52, the pulse generating unit 54 outputs pulse signals, and the pulse detecting unit 100 outputs the pulse interval time.

The speed measuring unit 110 calculates the rotating speed of the gear 56 by using the pulse interval time output from the pulse detecting unit 100. The data on the calculated rotating speed is stored in, for example, the RAM 311 (Step S102). At the subsequent Step S103, the frequency-characteristics calculating unit 111 determines whether the amount of rotating speed data, which is stored at Step S102, has reached the necessary amount of data. If it is determined that the amount of rotating speed data has not reached the necessary amount of data (Step S103, NO), the process proceeds to Step S107, which will be described later.

Conversely, if it is determined at Step S103 that the amount of rotating speed data, which is stored at Step S102, has reached the necessary amount of data (Step S103, YES), the process proceeds to Step S104. At Step S104, the frequency-characteristics calculating unit 111 uses the stored rotating speed data to analyze the frequency characteristics by performing, for example, a discrete Fourier transform. At the subsequent Step S105, the periodicity calculating unit 115 calculates an auto-correlation function for the rotating speed data that has been used for the analysis of the frequency characteristics at Step S104. At the subsequent Step S106, the gear-damage detecting unit 112 and the damaged-gear identifying unit 116 perform a damaged-gear detection process, which will be described later in detail. When the damaged-gear detection process is completed, the process proceeds to Step S107.

At Step S107, the driving control unit 101 monitors the pulse interval time and checks the rotating speed of the motor 52 by using the pulse interval time and the gear ratio of the gear 55 to the gear 56. At the subsequent Step S108, it is determined whether the rotating speed of the motor 52 matches the target speed. If it is determined that they match (Step S108, YES), the process proceeds to Step S112, which will be described later.

Conversely, if it is determined that the rotating speed of the motor 52 does not match the target speed (Step S108, NO), the driving control unit 101 proceeds to the process at Step S109 and determines whether the rotating speed of the motor 52 is higher than the target speed. If it is determined that the rotating speed of the motor 52 is higher than the target speed (Step S109, YES), the driving control unit 101 proceeds to the process at Step S110 and decreases the speed command value. Conversely, if it is determined that the rotating speed of the motor 52 is not higher than the target speed (Step S109, NO), the driving control unit 101 proceeds to the process at Step S111 and increases the speed command value. When the process at Step S110 or S111 is completed, the process proceeds to Step S112.

At Step S112, the driving control unit 101 determines whether a request has been received to stop the motor 52. If it is determined that a request has not been received to stop the motor 52 (Step S112, NO), the process returns to Step S101 and the motor 52 continues to be driven in accordance with the current speed command value. Conversely, if it is determined that a request has been received to stop the motor 52 (Step S112, YES), the driving control unit 101 proceeds to the process at Step S113 and sets the speed command value to 0 so that the driving of the motor 52 is stopped. Afterwards, the driving control unit 101 returns to the process at Step S100 and repeats the above-described process.

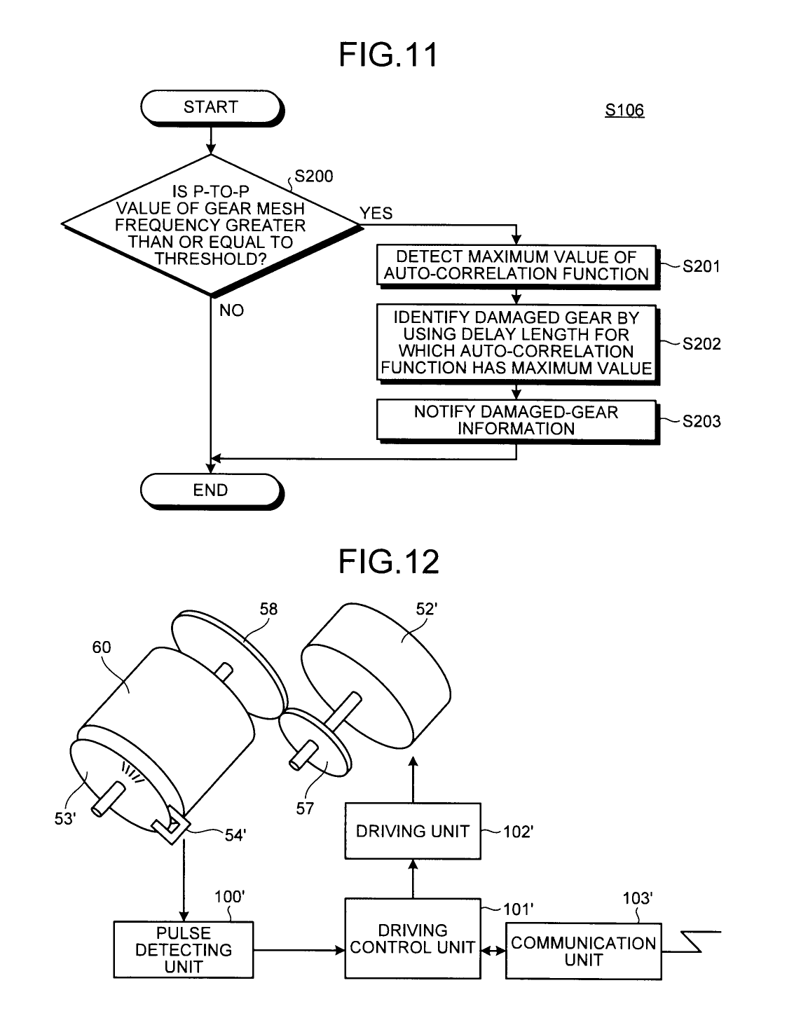

FIG. 11 is an exemplary flowchart that illustrates, in a more detailed manner, the damaged-gear detection process performed at Step S106 of the above-described flowchart in FIG. 10. First, at Step S200, the gear-damage detecting unit 112 determines whether the peak-to-peak value (P-to-P value) of the gear mesh frequency is greater than or equal to a threshold. If it is determined that the peak-to-peak value is not greater than or equal to the threshold (Step S200, NO), it is determined that the connected gears do not include a damaged gear; therefore, the process skips the flowchart in FIG. 11 and proceeds to Step S107 in FIG. 10.

Conversely, if it is determined at Step S200 that the peak-to-peak value of the gear mesh frequency is greater than or equal to the threshold (Step S200, YES), it is determined that the connected gears include a damaged gear. Therefore, a process is performed to identify the damaged gear among the connected gears. Specifically, if it is determined that the peak-to-peak value of the gear mesh frequency is greater than or equal to the threshold, the process proceeds from Step S200 to Step S201. The maximum-value detecting unit 130 of the damaged-gear identifying unit 116 then detects the peak that has the maximum peak value from the auto-correlation function, which has been calculated by the periodicity calculating unit 115, and obtains the peak delay time corresponding to the detected peak.

At the subsequent Step S202, the damaged-gear determining unit 131 compares the delay time of each gear, which is pre-stored in the delay-length storage unit 132, with the peak delay time obtained by the maximum-value detecting unit 130. The damaged-gear determining unit 131 then searches for the delay time that nearly matches the peak delay time among the delay times of the gears and then identifies the gear corresponding to the searched delay time as a damaged gear. The damaged-gear determining unit 131 notifies an external device of damaged-gear information that indicates the identified damaged gear (Step S203).

As described above, according to the first embodiment, it is determined whether the connected gears include a damaged gear on the basis of the frequency characteristics for the rotating speed of the gear. If it is determined that the connected gears include a damaged gear, the peak that has the maximum peak value is searched for with respect to the auto-correlation function for the rotating speed, and a damaged gear is identified from the connected gears. Thus, it is possible to easily identify a damaged gear among the connected gears with high accuracy.

### Modified Example of First Embodiment

Next, an explanation is given of a modified example of the first embodiment. In the above explanation, gear damage detection and damaged-gear identifying are performed on the gears in the driving system that drives the intermediate transfer belt 14; however, it is not limited to this example. For example, the above-described first embodiment can be applied to the driving system that drives the photosensitive drums included in the photosensitive units 12a to 12d.

FIG. 12 illustrates an exemplary configuration of the driving system that drives a photosensitive drum. A gear 57 is attached to the rotation shaft of a motor 52′, and the motor 52′ is driven by a driving unit 102′ under the control of a driving control unit 101′. A gear 58, which connects to the gear 57, is attached to the rotation shaft of a photosensitive drum (rotary drum) 60, and the photosensitive drum 60 is driven by the motor 52′ via the gear 57 and the gear 58 while the rotating speed of the motor 52′ is reduced.

In the example of FIG. 12, a code wheel 53′ is attached to the rotation shaft of the photosensitive drum 60. The code wheel 53′ and a pulse generating unit 54′ constitute a rotary encoder, and the code wheel 53′ rotates together with the photosensitive drum 60. Because the configurations of the code wheel 53′ and the pulse generating unit 54′ are the same as those explained with reference to FIG. 3 in the first embodiment, their detailed explanations are omitted here.

In FIG. 12, a pulse detecting unit 100′, the driving control unit 101′, the driving unit 102′, and a communication unit 103′ correspond to the pulse detecting unit 100, the driving control unit 101, the driving unit 102, and the communication unit 103, respectively, which are illustrated in FIG. 2 and described above. Specifically, the pulse detecting unit 100′ measures and outputs the time interval of the pulses of pulse signals output from the pulse generating unit 54′. The driving control unit 101′ refers to the pulse interval time so as to control the speed of the motor 52′. The driving unit 102′ drives the motor 52′ in response to a command received from the driving control unit 101′. The communication unit 103′ transmits and receives data to and from other components of the image forming apparatus 10 or an external device.

In this explanation, the pulse detecting unit 100′, the driving control unit 101′, the driving unit 102′, and the communication unit 103′ are arranged separately from the pulse detecting unit 100, the driving control unit 101, the driving unit 102, and the communication unit 103, which are illustrated in FIG. 2; however, it is not limited to this example. For example, part or all of the functions of the driving control unit 101′ and the communication unit 103′ can be common to the driving control unit 101 and the communication unit 103 in FIG. 2.

With the above configuration, the driving control unit 101′ may include the speed measuring unit 110, the frequency-characteristics calculating unit 111, the gear-damage detecting unit 112, the periodicity calculating unit 115, and the damaged-gear identifying unit 116, which are explained with reference to FIGS. 7 to 9 in the above-described first embodiment. With this configuration, the driving control unit 101′ can perform a process to determine whether the connected gears 57 and 58 include a damaged gear and, if the gears 57 and 58 include a damaged gear, perform a process to identify the damaged gear from the gears 57 and 58, as described in the first embodiment.

Furthermore, the first embodiment can be applied to not only the driving system used in the image forming apparatus 10 but also a driving system of a different device as long as the driving system includes multiple gears that are connected to each other to transmit power due to their rotations.

### Second Embodiment

Next, an explanation is given of a second embodiment. In the above-described first embodiment, if the connected gears include a damaged gear, the peak with the maximum peak value is detected with respect to the auto-correlation function for the measured rotating speed of the gear so that a damaged gear is identified. Conversely, according to the second embodiment, a ratio is obtained, which is the ratio between the value of the auto-correlation function corresponding to the rotation period, i.e., the delay time that is unique to each gear, which is obtained in advance in a state where each of the connected gears is a normal gear, and the value of the auto-correlation function, which is calculated by using the measured rotating speed with respect to one of the connected gears, corresponding to the delay time that is unique to each gear. Then, the value of the ratio obtained for each gear is compared with the threshold that is predetermined for each gear, and the gear whose rotation period corresponds to the delay time for which the value of the ratio exceeds the threshold is identified as a damaged gear.

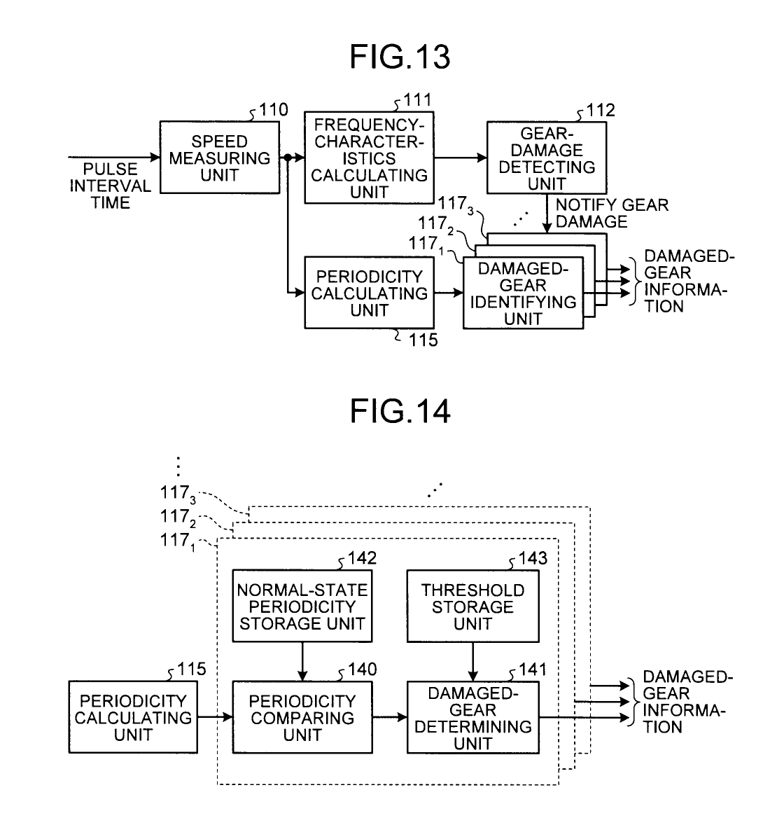

FIG. 13 illustrates an exemplary configuration of a damaged-gear detecting device according to the second embodiment. In FIG. 13, the same components as those described above in FIG. 7 are denoted by the same reference numbers, and their detailed explanations are omitted. Because the configuration of the gear-damage detecting unit 112 is the same as that explained with reference to FIG. 7 in the first embodiment, its detailed explanation is omitted here. According to the second embodiment, damaged-gear identifying units 117₁, 117₂, . . . that identify a damaged gear among the connected gears are provided corresponding to the number of connected gears. Specifically, each of the damaged-gear identifying units 117₁, 117₂, . . . has a different target gear to be identified among the connected gears.

In the same manner as the first embodiment, the damaged-gear detecting device according to the second embodiment can be used in the driving system for the intermediate transfer belt 14 of the image forming apparatus 10, the driving system for the photosensitive drum, and a driving system of a different device in which multiple gears are connected to each other to transmit a driving force due to their rotations. Furthermore, the configuration that is explained with reference to FIG. 3 in the first embodiment can be used in the same manner for the configuration of a rotary encoder that measures the rotating speed of a gear; therefore, its detailed explanation is omitted here.

FIG. 14 illustrates an exemplary configuration of the damaged-gear identifying units 117₁, 117₂, . . . In the following, if there is no need to discriminate the damaged-gear identifying units 117₁, 117₂, . . . from one another, the damaged-gear identifying units 117₁, 117₂, . . . are referred to as a damaged-gear identifying unit 117. The damaged-gear identifying unit 117 includes a periodicity comparing unit 140, a damaged-gear determining unit 141, a normal-state periodicity storage unit 142, and a threshold storage unit 143.

According to the second embodiment, an auto-correlation function is calculated in advance with respect to the rotating speed of each of the connected gears in the normal state where there is no damage, and the value of the auto-correlation function is obtained which corresponds to the delay time in accordance with the rotating speed of each gear. The obtained value of the auto-correlation function corresponding to the delay time in accordance with the rotating speed of each gear is pre-stored in the normal-state periodicity storage unit 142 of each of the damaged-gear identifying units 117₁, 117₂, . . .

The threshold storage unit 143 of each of the damaged-gear identifying units 117₁, 117₂, . . . pre-stores therein a threshold that is used for identifying a damaged gear among the connected gears. This threshold is set with respect to the value of the ratio between the value of the auto-correlation function during the delay time corresponding to the rotating speed of each gear, which is obtained in a state where each connected gear is a normal gear, and the value of the auto-correlation function, which is calculated by using the measured rotating speed with respect to one of the connected gears, during the delay time that is unique to each connected gear, as described above. For example, this threshold is experimentally obtained for each connected gear and is pre-stored in the threshold storage unit 143 of each of the damaged-gear identifying units 117₁, 117₂, . . . that correspond to the respective gears.

The auto-correlation function calculated by the periodicity calculating unit 115 is used by the periodicity comparing unit 140 of each of the damaged-gear identifying units 117₁, 117₂, . . . For example, in the damaged-gear identifying unit 117₁, the periodicity comparing unit 140 obtains the ratio between the value of the auto-correlation function stored in the normal-state periodicity storage unit 142 and the value of the auto-correlation function calculated by the periodicity calculating unit 115. Both of the values correspond to the rotation period of the target gear of the damaged-gear identifying unit 117₁.

The damaged-gear determining unit 141 compares the value of the ratio obtained by the periodicity comparing unit 140 with the threshold stored in the threshold storage unit 143 so as to determine whether the value of the ratio exceeds the threshold. If it is determined that the value of the ratio exceeds the threshold, it is determined that the damaged gear is the gear corresponding to the damaged-gear identifying unit 117 in which the damaged-gear determining unit 141 is included. This determination process is performed by each of the damaged-gear identifying units 117₁, 117₂, . . .

With reference to FIG. 6, which is described above, a more detailed explanation is given of the damaged-gear identifying process according to the second embodiment. For example, consideration is given to the case where the damaged-gear identifying unit 117₁ performs a determination process on the gear (referred to as the gear A) whose rotation period is 270 msec among the connected gears. In this case, the normal-state periodicity storage unit 142 pre-stores therein the value (the value for the peak 222 in FIG. 6) for the delay time of 270 msec among the values of the auto-correlation function, which is calculated in a state where the gear A is a normal gear without any damage.

The rotating speed of the gear A is measured while the gear A is driven, an auto-correlation function is calculated by using data on the measured rotating speed, and the value (the value for the peak 221 in FIG. 6) for the delay time of 270 msec is extracted from the calculated values. The periodicity comparing unit 140 obtains the ratio of the extracted value to the value stored in the normal-state periodicity storage unit 142. The damaged-gear identifying unit 117 compares the value of the ratio obtained by the periodicity comparing unit 140 with the threshold stored in the threshold storage unit 143.

Here, a damaged gear is identified by using the ratio of the value of the auto-correlation function, which is calculated on the basis of the measured value, to the value of the auto-correlation function, which is calculated and stored in advance; however, it is not limited to this example. For example, the value of the auto-correlation function for the delay length corresponding to the rotation period of each gear may be compared with the threshold that is set for each gear, and the gear, for which the value of the auto-correlation function exceeds the threshold, may be identified as a damaged gear. In this case, the periodicity comparing unit 140 and the normal-state periodicity storage unit 142 may be omitted from each of the damaged-gear identifying units 117₁, 117₂, . . .

Because the motor control and the damaged-gear detection process performed by the gear-damage detecting device according to the second embodiment are the same as those explained with reference to FIG. 10 according to the first embodiment, their explanations are omitted here.

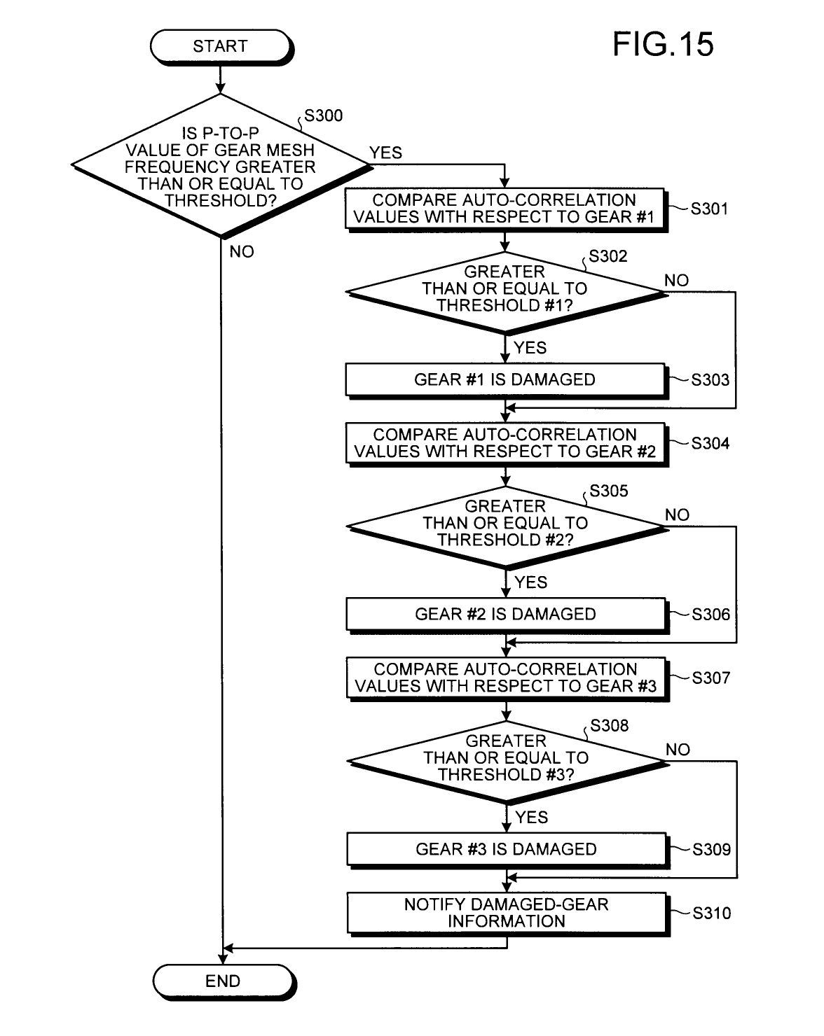

FIG. 15 is an exemplary flowchart that illustrates the damaged-gear detection process performed at Step S106 in a more detailed manner, where the process according to the flowchart, which is described above with reference to FIG. 10, is applied to the second embodiment. Here, three gears, i.e., a gear #1, gear #2, and gear #3 are connected to one another, and the gear-damage detecting device includes three damaged-gear identifying units 117, i.e., the damaged-gear identifying units 117₁, 117₂, and 117₃ that correspond to the gear #1, the gear #2, and the gear #3, respectively.

First, at Step S300, the gear-damage detecting unit 112 determines whether the peak-to-peak value of the gear mesh frequency is greater than or equal to the threshold. If it is determined that the peak-to-peak value is not greater than or equal to the threshold, it is determined that the connected gears do not include a damaged gear; therefore, the process skips the flowchart in FIG. 15 and proceeds to Step S107 in the flowchart of FIG. 10.

Conversely, if it is determined at Step S300 that the peak-to-peak value of the gear mesh frequency is greater than or equal to the threshold (Step S300, YES), it is determined that the connected gears include a damaged gear. Therefore, a process is performed to identify a damaged gear among the connected gears. Specifically, if it is determined that the peak-to-peak value of the gear mesh frequency is greater than or equal to the threshold, the process proceeds from Step S300 to Step S301.

The process from Steps S301 to S303 is performed by the damaged-gear identifying unit 117₁. At Step S301, the damaged-gear identifying unit 117₁ obtains, with respect to the gear #1, the ratio of the measured value of the auto-correlation function to the value of the auto-correlation function stored in the normal-state periodicity storage unit 142. At the subsequent Step S302, the damaged-gear determining unit 141 compares the value of the ratio obtained at Step S301 with the threshold for the gear #1 stored in the threshold storage unit 143 so as to determine whether the value of the ratio is greater than or equal to the threshold for the gear #1. If it is determined that the value of the ratio is less than the threshold for the gear #1 (Step S302, NO), it is determined that the gear #1 is not a damaged gear, and the process proceeds to Step S304. Conversely, if it is determined that the value of the ratio is greater than or equal to the threshold for the gear #1 (Step S300, YES), the gear #1 is identified as a damaged gear at the subsequent Step S303. Then, the process proceeds to Step S304.

Afterwards, the same process is repeated for the gears #2 and #3. Specifically, the process from Steps S304 to S306 is performed by the damaged-gear identifying unit 117₂. At Step S304, the damaged-gear identifying unit 117₂ obtains, with respect to the gear #2, the ratio of the measured value of the auto-correlation function to the value of the auto-correlation function stored in the normal-state periodicity storage unit 142. At Step S305, the value of the obtained ratio is compared with the threshold for the gear #2 stored in the threshold storage unit 143 (Step S305, NO). As a result of the comparison, if it is determined that the value of the ratio is less than the threshold for the gear #2 (Step S305, NO), it is determined that the gear #2 is not a damaged gear, and the process proceeds to Step S307. Conversely, if it is determined that the value of the ratio is greater than or equal to the threshold for the gear #2 (Step S305, YES), the process proceeds to Step S306 and the gear #2 is identified as a damaged gear. Then, the process proceeds to Step S307.

The subsequent process from Steps S307 to S309 is performed by the damaged-gear identifying unit 117₃. At Step S307, the damaged-gear identifying unit 117₃ obtains, with respect to the gear #3, the ratio of the measured value of the auto-correlation function to the value of the auto-correlation function stored in the normal-state periodicity storage unit 142. At Step S308, the value of the obtained ratio is compared with the threshold for the gear #3 stored in the threshold storage unit 143. As a result of the comparison, if it is determined that the value of the ratio is less than the threshold for the gear #3 (Step S308, NO), it is determined that the gear #3 is not a damaged gear, and the process proceeds to Step S310. Conversely, if it is determined that the value of the ratio is greater than or equal to the threshold for the gear #3 (Step S308, YES), the process proceeds to Step S309 and the gear #3 is identified as a damaged gear. Then, the process proceeds to Step S310.

At Step S310, each of the damaged-gear identifying units 117₁, 117₂, and 117₃ notifies an external device of the damaged-gear information.

In the above explanation, processes are serially performed by the damaged-gear identifying units 117₁, 117₂, and 117₃; however, it is not limited to this example. For example, the processes may be performed by the damaged-gear identifying units 117₁, 117₂, and 117₃ in parallel.

### Third Embodiment

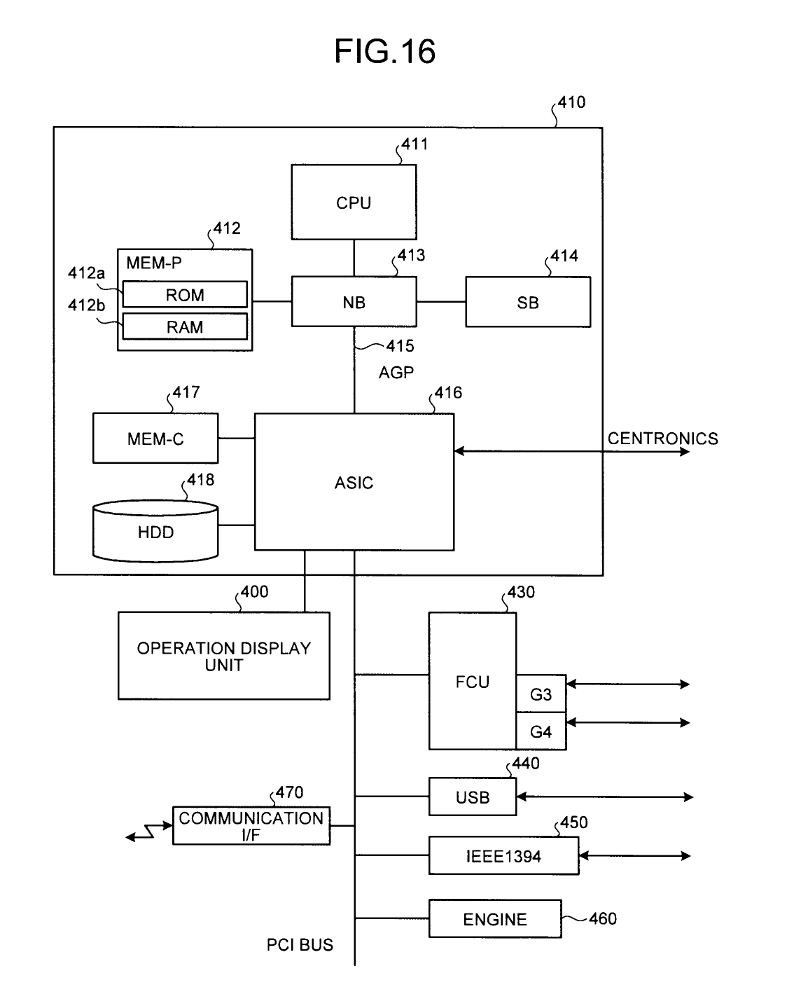

Next, an explanation is given of a third embodiment. The third embodiment includes an example of presenting, to a user, damaged-gear information that is output from the damaged-gear detecting device according to the above-described first embodiment, the modified example of the first embodiment, and the second embodiment. FIG. 16 illustrates an exemplary hardware configuration of a multifunction peripheral that can be used in each of the embodiments and the modified example. The multifunction peripheral illustrated in FIG. 16 may include the configuration of the image forming apparatus 10, which has been explained with reference to FIG. 1.

As illustrated in FIG. 16, the multifunction peripheral has a configuration in which a controller 410 and an engine unit (Engine) 460 are connected to each other via a peripheral component interface (PCI) bus. The controller 410 is a controller that controls the overall multifunction peripheral and controls drawings, communication, and input from an undepicted operation unit. The engine unit 460 is a printer engine, or the like, that is connectable to a PCI bus, for example, a black-and-white plotter, a one-drum color plotter, a four-drum color plotter, a scanner, or a fax unit. For example, the image forming apparatus 10 illustrated in FIG. 1 may be included in the engine unit 460. The engine unit 460 includes an image processing section for error diffusion, gamma transformation, or the like, in addition to what is called an engine section, such as a plotter.

The controller 410 includes a CPU 411, a north bridge (NB) 413, a system memory (MEM-P) 412, a south bridge (SB) 414, a local memory (MEM-C) 417, an application specific integrated circuit (ASIC) 416, and a hard disk drive (HDD) 418. The controller 410 has a configuration in which the north bridge (NB) 413 is connected to the ASIC 416 via an accelerated graphics port (AGP) 415. The MEM-P 412 further includes a ROM 412a and a RAM 412b.

The CPU 411 performs overall control of the multifunction peripheral. The CPU 411 includes a chip set made up of the NB 413, the MEM-P 412, and the SB 414 so that the CPU 411 is connected to other devices via the chip set. The CPU 411 may correspond to the CPU 310, which is illustrated in FIG. 4. Furthermore, the ROM 412a and the RAM 412b included in the MEM-P 412 may correspond to the ROM 312 and the RAM 311, which are illustrated in FIG. 4.

The NB 413 is a bridge that connects the CPU 411, the MEM-P 412, the SB 414, and the AGP 415. The NB 413 includes a memory controller that controls reading from and writing to the MEM-P 412, a PCI master, and an AGP target.

The MEM-P 412 is a system memory used as a memory for storing programs and data, a memory for loading programs and data, a memory for drawing by a printer, or the like. The MEM-P 412 includes the ROM 412a and the RAM 412b. The ROM 412a is a read-only memory used as a memory for storing programs and data, and the RAM 412b is a writable and readable memory used as a memory for loading programs and data, a memory for drawing by a printer, or the like.

The SB 414 is a bridge to connect the NB 413, a PCI device, and a peripheral device. The SB 414 is connected to the NB 413 via the PCI bus, and a network interface (I/F) unit, or the like, is also connected to the PCI bus.

The ASIC 416 is an integrated circuit (IC) intended for image processing that includes a hardware element for image processing, and has a function as a bridge to connect the AGP 415, the PCI bus, the HDD 418, and the MEM-C 417. The ASIC 416 includes a PCI target, an AGP master, an arbiter (ARB) that is the central core of the ASIC 416, a memory controller that controls the MEM-C 417, a plurality of direct memory access controllers (DMACs) that performs the rotation of image data, or the like, using hardware logic, and a PCI unit that performs data transfer with the engine unit 460 via the PCI bus. A facsimile control unit (FCU) 430, a universal serial bus (USB) 440, an IEEE 1394 (the Institute of Electrical and Electronics Engineers 1394) interface 450 are connected to the ASIC 416 via the PCI bus.

The MEM-C 417 is a local memory used as a copy image buffer or a code buffer. The hard disk drive (HDD) 418 is storage for storing image data, storing programs, storing font data, and storing forms.

The AGP 415 is a bus interface for a graphics accelerator card provided for speeding up graphics processes and directly accesses the MEM-P 412 at a high throughput so that the speed of the graphics accelerator card is increased.

A communication interface (I/F) 470 controls the communication with a network. For example, the communication I/F 470 can transmit, to the network, data that is fed from the CPU 411 via the NB 413, the AGP 415, the ASIC 416, and the bus. The communication I/F 470 can feed data, which is transmitted via the network, to the CPU 411 via the bus, the ASIC 416, the AGP 415, and the NB 413. The communication I/F 470 may correspond to the communication unit 103 illustrated in FIG. 2 and the communication unit 103′ illustrated in FIG. 12.

An operation display unit 400 is directly connected to the ASIC 416. The operation display unit 400 includes, for example, a display device, such as a liquid crystal display (LCD), an input device that uses multiple operators, a driving unit that generates display signals to be displayed by the display device in accordance with display control signals fed from the CPU 411, and a communication unit that transmits an output from the input device to the CPU 411.

For example, the CPU 411 generates display control signals in accordance with a program and then feeds the signals to the operation display unit 400 via the NB 413, the AGP 415, and the ASIC 416. Thus, the display device of the operation display unit 400 can display an image in accordance with the display control signals.

With the above configuration, each of the functions of the damaged-gear detecting device, which is illustrated in FIG. 7 or 13, is executed by using a program that is operated by the CPU 411. The CPU 411 generates display control signals to display damaged-gear information, which is output from, for example, the damaged-gear identifying unit 116 or 117, and then feeds the generated display control signals to the operation display unit 400 via the NB 413, the AGP 415, and the ASIC 416. In the operation display unit 400, the display device is driven in accordance with the fed display control signals, and the damaged-gear information is displayed on the display device in accordance with the display control signals. A user can easily know which gear is damaged in the driving system by using the damaged-gear information displayed on the operation display unit 400.

Furthermore, for example, the CPU 411 feeds the damaged-gear information, which is output from the damaged-gear identifying unit 116 or 117, to the communication I/F 470 via the NB 413, the AGP 415, the ASIC 416, and the bus. The communication I/F 470 transmits the fed damaged-gear information to a server that is connected via, for example, a network. Thus, it is possible to easily determine which gear is damaged in the driving system of the multifunction peripheral from a remote location with respect to the multifunction peripheral; thus, maintenance performance is improved.

The damaged-gear detection program executed by the driving control unit 101, 101′ (the CPU 310, the CPU 411) according to each of the above-described embodiments is provided by being installed in the ROM 312 (the ROM 412a), or the like, in advance. Furthermore, a configuration may be such that the damaged-gear detection program is provided by being stored, in the form of a file that is installable and executable, in a recording medium readable by a computer, such as a compact disk (CD), flexible disk (FD), digital versatile disk (DVD), or nonvolatile semiconductor memory. In this case, a drive device, which can read the above recording media, may be installed in the main body of the image forming apparatus 10 or the multifunction peripheral in which the driving control unit 101, 101′ is used, and the program provided by the recording medium may be received by the communication unit 103 via a network.

Furthermore, a configuration may be such that the damaged-gear detection program executed by the driving control unit 101, 101′ (the CPU 310, the CPU 411) according to each of the above-described embodiments is stored in a computer connected via a network, such as the Internet, and provided by being downloaded via the network due to the communication control performed by the communication unit 103. Moreover, a configuration may be such that the damaged-gear detection program is provided or distributed via a network such as the Internet.

### Fourth Embodiment

A configuration may be such that each function (the speed measuring unit 110, the frequency-characteristics calculating unit 111, the gear-damage detecting unit 112, the periodicity calculating unit 115, and the damaged-gear identifying unit 116) of the driving control unit 101, 101′ is included in an external device of the image forming apparatus. For example, in a production printing device, raster image processor (RIP) processing and printing of bit-mapped data, which is obtained by RIP processing, are performed by different devices. A detecting system (image forming system) according to a fourth embodiment is configured as a production printing device that includes a server device (digital front end (DEF)) that performs RIP processing and includes an image forming apparatus that performs printing processing. The server device has each of the above-described functions of the driving control unit 101, 101′.

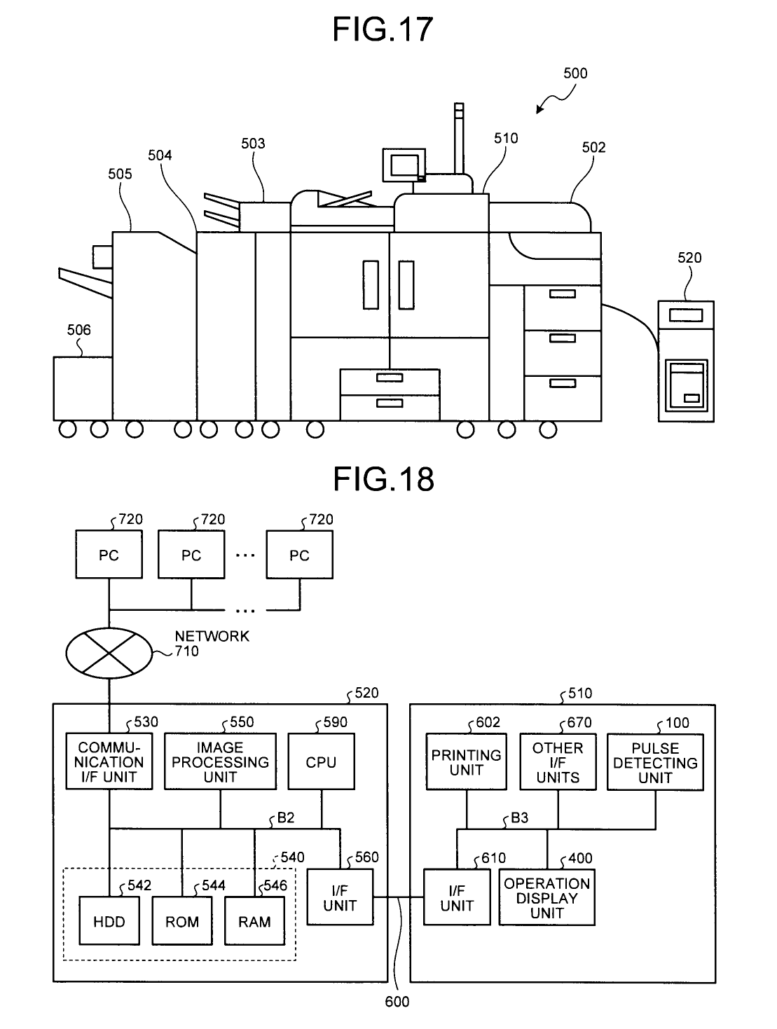

FIG. 17 is an external view of an example of a detecting system 500 according to the fourth embodiment. The detecting system 500 includes an image forming apparatus 510 and a server device 520. The detecting system 500 is, for example, a production printing device. When the detecting system 500 is used, a peripheral device that has the functions of sheet feeding, folding, stapling, cutting, and the like, is connected to the image forming apparatus 510. For example, in the detecting system 500, the image forming apparatus 510 is used in combination with peripheral devices, such as a large-volume feeding unit 502 that feeds sheets, an inserter 503 that is used for a cover sheet, or the like, a folding unit 504 that folds sheets, a finisher 505 that staples or punches sheets, or a cutting machine 506 that cuts sheets, depending on the intended use. The peripheral devices according to each of the above-described embodiments correspond to the large-volume feeding unit 502, the inserter 503, and the folding unit 504; however, the peripheral devices are not limited to these.

FIG. 18 is a block diagram that illustrates an exemplary configuration of the detecting system 500. As illustrated in FIG. 18, the server device 520 is connected to multiple personal computers (PCs) 720, which are host devices, via a network 710. The server device 520 can receive a print job that includes at least one set of print data from each of the PCs 720. The print job is a command signal to request printing of print data included in the print job. Any number of sets of print data (the number of copies) included in a print job can be set. Print data is described in a language, such as a page description language (PDL).

The server device 520 includes a communication I/F unit 530, a storage unit 540, an image processing unit 550, a CPU 590, and an I/F unit 560. They are connected to one another via a bus B2. In the example of FIG. 18, the server device 520 is connected to the image forming apparatus 510 via a dedicated line 600. The I/F unit 560 is a unit that connects the server device 520 to the image forming apparatus 510. The dedicated line 600 is connected to the I/F unit 560.

The communication I/F unit 530 is a unit that connects the server device 520 to the network 710. The communication I/F unit 530 can receive print jobs from each of the PCs 720.

The storage unit 540 includes an HDD 542, a ROM 544, and a RAM 546. The storage unit 540 can store therein print jobs received by the communication I/F unit 530. The HDD 542 and the ROM 544 are nonvolatile semiconductor memories. They store therein various programs executed by the server device 520 and various types of data (print jobs received by the communication I/F unit 530, and the like). The RAM 546 is a volatile semiconductor memory that temporarily stores therein various types of data when various programs stored in the HDD 542 and the ROM 544 are executed.

The image processing unit 550 performs image processing of print data included in a print job. More specifically, the image processing unit 550 converts print data, which is described in a page description language, such as PDL, into image data that is depicted in a format (e.g., bit-mapped format) printable by the image forming apparatus 510 and then feeds the image data to the image forming apparatus 510.

According to the present embodiment, the above-described functions of the driving control unit 101, 101′ are performed by the CPU 590, the RAM 546, and the ROM 544. For example, a configuration is such that the same functions as those of the CPU 310, the RAM 311, and the ROM 312, which are illustrated in FIG. 4, are performed by the CPU 590, the RAM 546, and the ROM 544.

As illustrated in FIG. 18, the image forming apparatus 510 includes an I/F unit 610, a printing unit 602, the above-described operation display unit 400, other I/F units 670, and the above-described pulse detecting unit 100. They are connected to one another via a bus B3. The I/F unit 610 is a unit that connects the image forming apparatus 510 to the server device 520. The dedicated line 600 is connected to the I/F unit 610.

Under the control of the CPU 590 of the server device 520, the printing unit 602 forms images on a recording sheet P by using image data fed from the image processing unit 550. In other words, under the control of the CPU 590, the printing unit 602 performs printing by using print data included in a print job.

The other I/F units 670 include the scanner unit 11, the peripheral devices illustrated in FIG. 17, and the like. That is, the other I/F units 670 includes interfaces that are necessary for forming images.

In the example of FIG. 18, the image forming apparatus 510 includes the pulse detecting unit 100; however, instead of the image forming apparatus 510, the server device 520 may include the pulse detecting unit 100.

The image forming apparatus 510 may have the same hardware configuration as that of the multifunction peripheral, which has been explained with reference to FIG. 16.

A program to be executed by the image forming apparatus 510 or the server device 520 is provided by being installed in a ROM (the ROM 544, the ROM 412a), or the like, in advance. Furthermore, a configuration may be such that the program is provided by being stored, in the form of a file that is installable and executable, in a recording medium readable by a computer, such as a CD-ROM, a flexible disk (FD), a CD-R, or a digital versatile disk (DVD). Furthermore, a configuration may be such that the program is stored in a computer connected via a network, such as the Internet, and provided by being downloaded via the network. Moreover, a configuration may be such that the program is provided or distributed via a network such as the Internet.

According to the embodiments as described above, it is possible to easily identify a damaged gear among connected gears.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A detecting device comprising:
a measuring unit that measures a rotating speed of at least one of connected gears;
a calculating unit that calculates frequency characteristics for the rotating speed measured by the measuring unit;
a detecting unit that detects a period of fluctuation of the rotating speed measured by the measuring unit;
a determining unit that determines whether the connected gears include a damaged gear by using the frequency characteristics calculated by the calculating unit; and
an identifying unit that, if the determining unit determines that the connected gears include a damaged gear, identifies a gear whose rotation period corresponds to the period detected by the detecting unit as the damaged gear among the connected gears.

2. The detecting device according to claim 1, wherein the detecting unit calculates an auto-correlation function for the rotating speed measured by the measuring unit and detects the period of fluctuation by using the calculated auto-correlation function.

3. The detecting device according to claim 2, wherein the detecting unit detects, within a predetermined range of delay times, a delay time at which a value of the auto-correlation function becomes the maximum peak value as the period of fluctuation.

4. The detecting device according to claim 2, wherein the detecting unit detects a delay time corresponding to the rotation period of a target gear among the connected gears as the period of fluctuation if a value of the auto-correlation function at the delay time exceeds a threshold.

5. The detecting device according to claim 2, wherein the detecting unit detects a delay time corresponding to the rotation period of a target gear among the connected gears as the period of fluctuation if a ratio between a value of the auto-correlation function at the delay time and a value of the auto-correlation function at the delay time in a state where the connected gears do not include the damaged gear exceeds a threshold.

6. The detecting device according to claim 1, wherein the determining unit determines that the connected gears include a damaged gear on the basis of the frequency characteristics if a peak value of a mesh frequency of the connected gears exceeds a threshold.

7. An image forming apparatus comprising:
a sheet conveying unit that conveys a sheet by using a moving body, the moving body being driven via connected gears;
an image forming unit that forms an image on the sheet conveyed by the sheet conveying unit by using a rotary drum that is driven and rotated via connected gears; and
the detecting device according to claim 1, the detecting device detecting damage to at least one of the connected gears of the sheet conveying unit and the image forming unit.

8. The image forming apparatus according to claim 7, further comprising a display unit that displays information that indicates the damaged gear identified by the identifying unit.

9. The image forming apparatus according to claim 7, further comprising a communication unit that performs communication with an external device via a network, wherein
the communication unit transmits information that indicates the damaged gear identified by the identifying unit to the external device.

10. A computer program product comprising a non-transitory computer readable medium including programmed instructions, wherein the instructions, when executed by a computer, cause the computer to execute:
measuring a rotating speed of at least one of connected gears;
calculating frequency characteristics for the rotating speed measured at the measuring;
detecting a period of fluctuation of the rotating speed measured at the measuring;
determining whether the connected gears include a damaged gear by using the frequency characteristics calculated at the calculating; and
identifying, if it is determined at the determining that the connected gears include a damaged gear, a gear whose rotation period corresponds to the period detected at the detecting as the damaged gear among the connected gears.

11. A detecting system for detecting damage to connected gears, comprising:
a device that includes the connected gears and an output unit that outputs a signal in accordance with rotation of at least one of the connected gears;
a measuring unit that measures a rotating speed of at least one of the connected gears in accordance with the signal output from the output unit;
a calculating unit that calculates frequency characteristics for the rotating speed measured by the measuring unit;
a detecting unit that detects a period of fluctuation of the rotating speed measured by the measuring unit;
a determining unit that determines whether the connected gears include a damaged gear by using the frequency characteristics calculated by the calculating unit; and
an identifying unit that, if the determining unit determines that the connected gears include a damaged gear, identifies a gear whose rotation period corresponds to the period detected by the detecting unit as the damaged gear among the connected gears.
